(19) United States
(12) Patent Application Publication
(10) Pub. No.: US 2009/0053383 A1
(43) Pub. Date: Feb. 26, 2009

(54) ANGELICA KEISKEI TEA

(75) Inventors: Hiroshi ENDO, Otsu-shi (JP); Yasushi Hattori, Otsu-shi (JP); Hitoshi Sakakibara, Otsu-shi (JP); Katsumi Sugiyama, Otsu-shi (JP); Yuko Asai, Otsu-shi (JP); Satoko Motomura, Otsu-shi (JP); Ikunoshin Kato, Otsu-shi (JP)

Correspondence Address: BROWDY AND NEIMARK, P.L.L.C.;624 NINTH STREET, NW, SUITE 300, WASHINGTON, DC, 20001-5303, US

(73) Assignee: TAKARA BIO INC., Otsu-shi (JP)

(21) Appl. No.: 12/176,088

(22) Filed: Jul. 18, 2008

(30) Foreign Application Priority Data
Jul. 18, 2007 (JP) 2007-187592
Dec. 27, 2007 (JP) 2007-336780

(51) Int. Cl. A23F 3/06; A23F 3/22

(52) U.S. Cl. 426/597; 426/640

(57) ABSTRACT

According to the present invention, there are provided kneading-free Angelica keiskei tea leaves obtainable by a treatment comprising a step for roast-heating a dried material of Angelica keiskei; an Angelica keiskei tea beverage produced by using the kneading-free Angelica keiskei tea leaves; and a process for producing thereof. The Angelica keiskei tea leaves are preferably heated at a heating temperature of 100° C. to 150° C. in the roast-heating treatment, and the dried material of Angelica keiskei to be subjected to the roast-heating is preferably obtained by drying in a dried system after blanching and has a moisture content of 20% or less. Further, according to the present invention, there is also provided an Angelica keiskei chalcone function-formulated beverage comprising formulated Angelica keiskei chalcones that are components specific to Angelica keiskei.

### TECHNICAL FIELD

The present invention relates to Angelica keiskei tea leaves having excellent taste, an Angelica keiskei tea beverage, and a process for producing thereof.

### BACKGROUND ART

Angelica keiskei (Angelica keiskei Koidz.) is a large perennial herb and belongs to Apiaceae family, and various health promoting effects thereof have been known. For example, as bioactivities of Angelica keiskei, an antibacterial activity, an antitumor activity, a gastric acid antisecretory activity, an anticancer activity, a nerve growth factor (NGF) production potentiating activity, and a hepatocellular growth factor production potentiating activity have been known (see, for example, Patent Document 1). In addition, Angelica keiskei is known to have an antidiabetic activity owing to its insulin-like activity (see, for example, Patent Document 2).

As characteristic components contained in Angelica keiskei, chalcone compounds whose representative examples include xanthoangelol and 4-hydroxyderricin are known. The chalcone compounds have specific chemical structures and are one kind of polyphenols. In recent years, it has been reported that the chalcone compounds have versatile physiological activities, and examples of the known activities include an anticancer activity, an antibacterial activity, an antivirus activity, a cellulite resolution activity, a NGF production potentiating activity, an antidiabetic activity and the like (see, for example, Patent Documents 3 and 4, and Non-Patent Document 1).

It has been confirmed that both of xanthoangelol and 4-hydroxyderricin (hereinafter collectively referred to as Angelica keiskei chalcones) that are the principal chalcone compounds contained in Angelica keiskei have an insulin-like activity. The Angelica keiskei chalcones have the same physiological activity as that of insulin, i.e. both of an activity for differentiating precursor adipocytes into adipocytes and an activity for promoting glucose uptake into the differentiated adipocytes, and is confirmed to exhibit a diabetes improvement effect and a diabetes prophylactic effect in animal experiments. Therefore, the compounds are expected to exhibit the effects as a drug or a health food material.

As a conventional process for producing Angelica keiskei tea using Angelica keiskei as a raw material, for example, there has been known a process similar to a process for producing natural leaf tea, i.e., a process for producing Angelica keiskei tea comprising subjecting buds of Angelica keiskei to a steaming and cooling step, and after compression, to a coarse kneading step and rolling step in turn, and further to an intermediate kneading step for heating and drying, followed by fine kneading and final drying (see, for example, Patent Document 5).

For the reason that some may keep away from the taste of the Angelica keiskei tea obtained by the above-described conventional process because such Angelica keiskei tea has a peculiar grassy smell and a vegetable-like taste, Patent Document 6 discloses a process for producing Angelica keiskei tea comprising subjecting a raw material to natural leaf tea production steps including a steaming and cooling step, a coarse kneading step, and finishing rolling step to obtain natural leaf tea-like Angelica keiskei tea, then subjecting the resultant to heat-drying, and roasting the dried natural leaf tea-like product by a cylindrical roast-dryer.

[Patent Document 1] WO 01/76614

[Patent Document 2] WO 2004/014407

[Patent Document 3] WO 01/54682

[Patent Document 4] WO 2004/096198

[Patent Document 5] JP 61-158766 A

[Patent Document 6] JP 1-262781 A

[non-Patent Document 1] J. R. Dimmock and three others, Current Medicinal Chemistry, 1999, Vol. 6, pp. 1125 to 1149.

### DISCLOSURE OF THE INVENTION

### Problem to be Solved by the Invention

An object of the present invention is to provide Angelica keiskei tea leaves and an Angelica keiskei tea beverage whose grassy smell, vegetable-like taste, and harsh taste that are peculiar to Angelica keiskei are reduced, whose flavor is improved, and which can be produced by a simple process. Also provided is a process for producing thereof.

### Means for Solving the Problem

The present inventors have intensively studied for developing an Angelica keiskei tea beverage whose grassy smell, vegetable-like taste, and harsh taste that are peculiar to Angelica keiskei are reduced as well as whose flavor is improved. As a result, they have surprisingly found that an Angelica keiskei tea beverage excellent in taste can be obtained by using Angelica keiskei leaves produced without carrying out a coarse kneading step and the like that have been carried out in a conventional Angelica keiskei tea leaves production, and subjecting the leaves to a roast-heating treatment, thereby completing the present invention.

That is, a first invention of the present invention relates to kneading-free Angelica keiskei tea leaves obtainable by a treatment comprising a step for roast-heating a dried material of Angelica keiskei.

In the first invention of the present invention, the roast-heating treatment can be selected in a temperature range within which the grassy smell, the vegetable-like taste, and the harsh taste are alleviated. Further, this treatment imparts a roast aroma to the Angelica keiskei tea leaves to make it possible to provide Angelica keiskei tea leaves and an Angelica keiskei tea beverage having a unique flavor. The roast aroma can be imparted by a heating treatment equivalent to a roast treatment, and one example thereof is a broiling treatment. As a broiling treatment method, the broiling treatment method disclosed in JP 3-175970 A has been known, and it is possible to subject the dried material of Angelica keiskei to a broiling treatment by the method.

As the aspect of the first invention, there is mentioned the kneading-free Angelica keiskei tea leaves which has been subjected to the roast-heating treatment at a heating temperature of 100° C. to 150° C. Further, examples of the dried material of Angelica keiskei of the first invention include a dried material of Angelica keiskei having a moisture content of 20% or less which is obtained by a dry heating treatment after blanching. The dry heating treatment is not particularly limited, and conventional dry heating that is capable of efficiently removing moisture of Angelica keiskei can be employed.

A second invention of the present invention relates to an Angelica keiskei tea beverage produced by using the kneading-free Angelica keiskei tea leaves of the first invention of the present invention. As one aspect thereof, there is provided the Angelica keiskei tea beverage subjected to retort sterilization, and the flavor of the Angelica keiskei tea beverage is improved by retort sterilization carried out in the presence of an antioxidant.

A third invention of the present invention relates to an Angelica keiskei tea beverage comprising formulated Angelica keiskei chalcones. The beverage is an Angelica keiskei tea beverage to which functions of the Angelica keiskei chalcones are imparted, and it is possible to enjoy the functions of the Angelica keiskei chalcones simply by ingesting the beverage.

As the aspect of the third invention, there is mentioned the Angelica keiskei tea beverage obtained by adding the Angelica keiskei chalcones to the Angelica keiskei tea beverage of the second invention of the present invention.

The fourth and the fifth invention relate to production processes of the first and the second invention of the present invention, respectively.

### EFFECT OF THE INVENTION

According to the present invention, there are provided Angelica keiskei tea leaves whose grassy smell, vegetable-like taste, and harsh taste that are peculiar to Angelica keiskei are reduced as well as whose flavor in terms of richness, sweetness, and aroma is improved; a high quality Angelica keiskei tea beverage having mellowness in addition to the above-described characteristics; an Angelica keiskei tea beverage comprising formulated Angelica keiskei chalcones; and a process for producing thereof. Since the production process does not include any kneading steps such as coarse kneading, rolling, intermediate kneading, or fine kneading, the production process is extremely simplified as compared with a conventional process and is suitable for producing a health tea having a refreshing taste.

### BEST MODE FOR CARRYING OUT THE INVENTION

Hereinafter, the present invention will be explained in detail.

The Angelica keiskei tea leaves of the present invention are produced by using fresh Angelica keiskei as a raw material. There is no particular limitation as to which part of a Angelica keiskei raw material is to be used for the production, and it is possible to appropriately select among fruits, seeds, seed skins, flowers, leaves, stems, and entire parts. The stems, the leaves, or a mixture thereof can be preferably used for the production. That is, the “Angelica keiskei tea leaves” of the present invention is not limited to only those from leaves as a raw material and encompasses those produced from a single part of a Angelica keiskei raw material or from mixed parts of a Angelica keiskei raw material in combination.

A roasted material of the stem origin is capable of increasing the aroma and the sweetness of the Angelica keiskei tea beverage. Also, since a roasted material of the leaves origin enables the production of an Angelica keiskei tea beverage having a premium accent, it is possible to adjust the flavor and quality of the Angelica keiskei tea leaves and the Angelica keiskei tea beverage by adjusting proportions of parts of an Angelica keiskei raw material. Further, an Angelica keiskei tissue or cell culture that is industrially cultured by a tank culture or the like can also be used.

The expression, “kneading-free Angelica keiskei tea leaves”, used herein means Angelica keiskei tea leaves produced without carrying out a kneading operation of an Angelica keiskei raw material. The kneading operation means the step for kneading tea leaves that is conventionally carried out in a natural leaf tea production, such as coarse kneading, rolling, intermediate kneading or fine kneading.

The Angelica keiskei tea leaves and the Angelica keiskei tea beverage of the present invention encompass any products as far as they contain at least Angelica keiskei in their raw materials, and examples thereof include blended tea leaves obtained by mixing with a raw material other than the Angelica keiskei and an Angelica keiskei tea beverage using such blended tea leaves. Since the Angelica keiskei tea beverage of the present invention is stable against heating for sterilization and excellent in storage, the Angelica keiskei tea beverage is suitably provided as a beverage packed in a container such as a can, a bottle, and a PET bottle.

The process for producing Angelica keiskei tea leaves of the present invention includes as the essential steps a drying step and a roasting step, and the Angelica keiskei tea beverage of the present invention is produced by using the Angelica keiskei tea leaves obtained by such a production process. Hereinafter, examples of the production processes of the Angelica keiskei tea leaves and the Angelica keiskei tea beverage of the present invention will be described but the present invention is not limited thereto. The Angelica keiskei tea leaves of the present invention is produced by (1) blanching, (2) shredding, (3) drying, and (4) roasting, and the Angelica keiskei tea beverage of the present invention include (5) extraction of an Angelica keiskei tea beverage from the Angelica keiskei tea leaves obtained by the above-described steps (1) to (4), (6) blending, and (7) filling and sterilization.

(1) Blanching Step

Blanching is carried out for the purpose of preventing discoloration and deterioration in taste of an Angelica keiskei raw material to be used as the raw material and is carried out by dipping into hot water or steam blowing in practice. Although a particular method can be appropriately selected for a particular purpose, steam blanching is preferred in view of prevention of reduction of components in the raw material. In this method, it is possible to use a known steamer, such as a meshed cylindrical rotating steamer, a meshed cylindrical rotating stirring steamer, an autoclave, and a conveyer type steamer. Further, for dipping into hot water, a hot water dipping apparatus can be used. In this step, it is preferable to cool down the Angelica keiskei raw material with a cold water or cold air after blanching for the purpose of prevention of discoloration and deterioration in taste of the Angelica keiskei raw material. The above-mentioned steamer is composed of a steam generation device, a steaming device, a leaves feeding device, a cooling device, and the like, and it is preferable to use such apparatus.

There is no limitation of blanching conditions, and the conditions can be appropriately adjusted depending on a harvest time and a size. For example, the Angelica keiskei raw material is heated by saturated steam or hot water of 90° C. or more for 10 to 300 seconds, preferably 30 to 60 seconds to carry out sterilization and heat processing thereof. By such a heat treatment, it is possible to prevent browning during drying through inactivation of oxidases in the Angelica keiskei raw material. Subsequently, the Angelica keiskei raw material subjected to the heat treatment is subjected to a cooling treatment to prevent the Angelica keiskei raw material from being further steamed with heat, thereby obtaining a raw material for the Angelica keiskei tea leaves and the Angelica keiskei tea beverage having good taste, color, and aroma.

(2) Shredding Step

The shredding step is a step for obtaining small pieces of the Angelica keiskei raw material and can be carried out if necessary. There is no particular limitation for the shredding method, and it is preferable to shred the Angelica keiskei raw material after the blanching treatment into strips of about 5 to 20 mm wide. By the shredding, it is possible to obtain small pieces of the Angelica keiskei raw material as well as to prevent uneven drying that is otherwise caused by overlapping parts of the Angelica keiskei raw material during a subsequent drying treatment. This shredding step can be carried out by using a known shredding apparatus such as guillotine type or a blade rotating shredding machine or can be carried out manually.

(3) Drying Step

The drying step is carried out by subjecting the Angelica keiskei raw material to a dry heating treatment (hereinafter simply referred to as a drying treatment in some cases). Though a dried material to be obtained by the drying step is not particularly limited as far as moisture in the Angelica keiskei raw material is efficiently removed and the subsequent roasting step is efficiently carried out, a moisture content of the dried material is preferably 20% or less, more preferably 10% or less, further preferably 7% or less.

The drying method is not particularly limited, and, for example, the number of drying treatment may be once or plural times. Examples of the single drying treatment include such a method that the drying treatment is carried out at 40° C. to 100° C. for 1 hour to 1 week by using a box type air-flow dryer.

In order to more efficiently carry out the drying of Angelica keiskei, plural times of the drying treatments are preferred, wherein, for example, two-step drying treatments can be carried out under different conditions. For example, in the first drying treatment, an almost all of the moisture contained in the Angelica keiskei raw material is removed by heating at a drying chamber temperature of 80° C. to 180° C., which is a relatively high temperature, for 10 minutes to 5 hours while stirring the Angelica keiskei after the shredding treatment. It is preferable to select the conditions under which a rise in a product temperature of the Angelica keiskei raw material is suppressed by deprivation of vaporization heat of water.

As the dryer used for the first drying treatment, a known dryer can be used, and examples thereof include a rotating air-flow dryer, a continuous horizontal fluidized dryer, a vibro-fluidized bed dryer, a belt type dryer, and the like.

It is possible to obtain the dried material of Angelica keiskei suitably used for the present invention by treating the Angelica keiskei raw material from which almost all part of moisture has been removed at a lower temperature for a longer time in the second drying treatment. For example, this drying treatment is carried out at a relatively low temperature of 40° C. to 80° C. for 1 to 72 hours. As a dryer to be used in the second drying treatment, a known dryer can be used, and examples thereof include a box type air-flow dryer, a continuous vacuum dryer, a stirring dryer, a flash dryer, a dryer using a microwave, and the like.

(4) Roasting Step

The roasting step in the present invention is a step for subjecting the dried material of Angelica keiskei obtained without carrying out any kneading step, i.e. obtained by carrying out the above-described steps (1) to (3), to a roast-heating treatment rather than carrying out a roast-heating treatment of Angelica keiskei after harvest and coarse kneading, thereby reducing a raw smell of a tea beverage when an Angelica keiskei beverage is produced by using the kneading-free Angelica keiskei tea leaves produced by the above-described step. That is, the Angelica keiskei tea leaves of the present invention are obtained by carrying out the roast-heating treatment of the Angelica keiskei raw material obtained by the drying step without carrying out a kneading step of Angelica keiskei.

If necessary, large stems or the like may be sorted out and removed from the Angelica keiskei raw material before the roasting step. As the method for subjecting the dried material of Angelica keiskei to the roast-heating treatment, a known roaster can be used, and examples thereof include an exhaust drying roaster, a flat pan, an oven, a gas roaster, an electrothermal heater, a hot-air roaster, a far infrared ray machine, a rotary fluid roaster, a gas fluid bed roaster, a fluid bed roaster with microwave, a double cylinder type roasting drier, and the like.

The roast-heating treatment can be carried out at a temperature range that enables reductions in grassy smell, vegetable-like taste, and harsh taste. Further, it is possible to provide the Angelica keiskei tea leaves and the Angelica keiskei tea beverage having a unique flavor since a roast aroma is imparted to the Angelica keiskei tea leaves by the treatment. Such roast aroma can be imparted by a heat treatment equivalent to the roast-heating treatment, and one example thereof is a broiling treatment. Examples of the broiling treatment method include the broiling treatment method disclosed in JP 3-175970 A, and the dried material of Angelica keiskei can be subjected to the broiling treatment by this method. The kneading-free Angelica keiskei tea leaves obtained by the treatment including a broil-heating step of the dried material of Angelica keiskei are also encompassed by the present invention.

The expression “heating temperature in the roast-heating treatment” (hereinafter simply referred to as the roasting temperature) as used herein means a preset achieving temperature of a material to be roasted (the dried material of Angelica keiskei) in the roasting step, i.e. a temperature of the dried material of Angelica keiskei finally reached by placing the dried material of Angelica keiskei in the roaster and raising the inside temperature of the roaster. Also, the roasting time means the time required for reaching to the preset temperature from a start of heating, and the roasted material is taken out after reaching to the preset temperature.

The roasting temperature is not particularly limited and can appropriately be selected from 100° C. to 300° C., for example. When the roast-heating treatment is carried out at a low temperature, it is possible to obtain a roast-heated material having sweetness and excellent in green color, while leaving the raw smell (harsh taste) peculiar to Angelica keiskei. On the other hand, when the roast-heating treatment is carried out at a high temperature, it is possible to obtain the Angelica keiskei tea leaves having a roast aroma, while resulting in discoloration. But a too high temperature causes a too strong burnt taste resulting in deterioration in palatability. From such view points, the roasting temperature in the present invention is preferably 100° C. to 150° C., and it is possible to set the roasting temperate to 100° C. to 120° C. in the case of emphasizing on sweetness of tea leaves and a tea beverage to be obtained or to 120° C. to 150° C. in the case of emphasizing on aroma of tea leaves and a tea beverage to be obtained. Further, in the case of using only the leaves of Angelica keiskei as the raw material, the roasting temperature can preferably be 120° C. to 150° C. as described in Example 14 hereinafter. Also, it is possible to use Angelica keiskei tea leaves obtained by mixing Angelica keiskei tea leaves prepared at different roasting temperatures in the extraction step described hereinafter. Further, it is possible to obtain the Angelica keiskei tea beverage by blending extracts of Angelica keiskei tea leaves prepared at different roasting temperatures. In the case of carrying out heat sterilization such as in the case of carrying out retort sterilization in the sterilization step, it is preferable to select the relatively high roasting temperature in producing the Angelica keiskei tea leaves in view of influence of heating on the flavor of the Angelica keiskei tea beverage. For example, it is better to use a mixture of equal parts of the Angelica keiskei tea leaves obtained by the roast-heating treatment at 110° C. and the Angelica keiskei tea leaves obtained by the roast-heating treatment at 135° C., or the Angelica keiskei tea leaves obtained by the roast-heating treatment at 120° C.-140° C. than to use only the Angelica keiskei tea leaves obtained by the roast-heating treatment at 110° C., and, particularly, a sole use of the Angelica keiskei tea leaves obtained by the treatment at 135° C. is preferred.

By the above-mentioned steps (1) to (4), the Angelica keiskei tea leaves of the present invention can be obtained Although it is possible to use the Angelica keiskei tea leaves of the present invention as they are in the extraction step described hereinafter, it is possible to obtain tea bag type Angelica keiskei tea leaves as described in Examples 11, 14, and 15.

(5) Extraction Step

The Angelica keiskei tea beverage of the present invention is produced by carrying out an extraction step using the Angelica keiskei tea leaves obtained by the roasting step with an appropriate solvent. The extraction step can be carried out by preparing a high concentration extract by using a large amount of the Angelica keiskei tea leaves and diluting the extract with hot water or water in the blending step described hereinafter, or an extract having an appropriate concentration can be used as it is for the blending step. The amount of the Angelica keiskei tea leaves used in the extraction step is not particularly limited and can be used in an amount 0.25 to 3% w/v, preferably 0.5 to 2% w/v relative to an extraction solvent from the view points of richness, sweetness, and aroma of the tea beverage to be obtained. The extraction solvent is not particularly limited as far as water for drinking purpose, but it is preferable to use demineralized water or distilled water.

The extraction method is not particularly limited, and a conventional method such as a stirring extraction can be carried out. For example, a method of extracting under a non-oxidation atmosphere obtained by eliminating a dissolved air by boiling deaeration or by supplying an inert gas such as a nitrogen gas, for example, that disclosed in Japanese Patent No. 3484612 can be employed.

Further, an antioxidant can be added to the extraction solvent before the extraction step or to the tea beverage obtained after the extraction step. The antioxidant is not particularly limited, and it is preferable to use ascorbic acid or ascorbate. The amount of the ascorbic acid or ascorbate relative to the extraction solvent and/or the tea beverage after the extraction is not particularly limited, but, from the view point of the antioxidation effect and sensory reasons such as richness, sweetness, and aroma of the tea beverage to be obtained, the amount is preferably in the range of 0.001 to 1.0% w/v, more preferably 0.002 to 0.5% w/v, further preferably 0.005 to 0.2% w/v.

The ascorbic acid or ascorbate can preferably be added to the extraction solvent before the extraction step from the view point of an antioxidation effect and richness, sweetness, and aroma of the taste of the tea beverage to be obtained.

Additionally, a carbonate, a phosphate, and the like, which are food additives, can be added during the extraction step if necessary for the purposes of improvement in extraction efficiency, neutralization, and the like. Examples of the carbonate include potassium carbonate, sodium hydrogencarbonate (alias: baking soda), sodium carbonate, and the like. Also, examples of the phosphate include disodium phosphate, trisodium phosphate, dipotassium phosphate, tripotassium phosphate, and the like.

The temperature of the extraction solvent is not particularly limited and is preferably 35° C. or more, more preferably 50° C. or more from the view point of richness, sweetness, and aroma of the tea beverage to be obtained, further preferably 65° C. to 100° C. The extraction time is not particularly limited either, and can be selected from the view point of richness, sweetness, and aroma of the tea beverage to be obtained. For example, the extraction time is preferably a few seconds to 1 hour, more preferably 30 seconds to 40 minutes, and further preferably 1 to 15 minutes.

(6) Blending Step

The blending step is a step to be carried out for the purposes of adjusting and strengthening a taste and flavor of the tea beverage or of imparting functions, if necessary. In this step, a flavor material, a sweetener (sugar, sucralose, erythritol, xylitol, a luohanguo extract, etc.), a stabilizer (pectin, carrageenan, soy bean polysaccharide, etc.), a fruit juice, a fruit juice powder, a vegetable extract, a vegetable paste, a sea weed-derived ingredient, a sea weed extract (e.g. a fucoidan-containing substance, agalooligosaccharide-containing substance, etc.), a mushroom powder, a dried powder, a roasted material, or a fermented extract of a plant such as Angelica keiskei Koidz., an ingredient known as a health food material (banaba extract, a Gynostemma pentaphyllum extract, a lycium chinense miller leaf extract, a mulberry leaf extract, indigestible dextrin, various vitamins, etc.) can be added to the tea beverage. A reducing agent can also be added to the tea beverage. Also, for the purpose of neutralization and the like, food additives such as those described above including a carbonate, a phosphate, and the like can be added, if necessary. Further, in the case where the high concentration extract liquid is obtained in the above extraction step, it is possible to dilute the extract with hot water or water in this step.

In this step, it is possible to add the Angelica keiskei chalcones or a composition containing such compounds to the tea beverage to formulate Angelica keiskei chalcones in the Angelica keiskei tea beverage. As used herein, the Angelica keiskei chalcones mean the chalcone compounds contained in Angelica keiskei such as 4-hydroxyderricin and xanthoangelol or a mixture of 4-hydroxyderricin and xanthoangelol. The composition containing Angelica keiskei chalcones to be added to the tea beverage is not particularly limited, and examples thereof include an Angelica keiskei extract produced by extraction from the Angelica keiskei Koidz. with ethanol or hydrous ethanol. The Angelica keiskei extract obtained by the hydrous ethanol extraction to be used in the present invention is an extract containing the Angelica keiskei chalcones at a high concentration and is added and blended in the case of producing a tea beverage exhibiting physiological activities of the Angelica keiskei chalcones. Since the Angelica keiskei chalcones are water-insoluble compounds, it is considered that conventional Angelica keiskei tea beverages do not contain the Angelica keiskei chalcones, or, if contained, the amount is very small. As the Angelica keiskei extract obtained with hydrous ethanol, the one obtained by extraction with an aqueous 40% to 95% (w/w) ethanol solution as disclosed in JP 2007-176919 A is preferred, and the one improved in solubility by addition of an emulsifier is further preferred. The extract obtained with hydrous ethanol is suitably used as a material for beverages because it contains the Angelica keiskei chalcones at a high concentration, is soluble in water, has good systemic absorption, and is reduced in harsh taste and grassy smell that are peculiar to Angelica keiskei. In the case of providing the tea beverage containing the Angelica keiskei chalcones as one aspect of the Angelica keiskei tea beverage of the present invention, it is possible to provide the tea beverage as a functional beverage utilizing the physiological activities of the Angelica keiskei chalcones. For example, it is possible to provide the tea beverage as a food expected to exhibit the physiological activities such as an effect of lowering a blood-glucose level and an effect of increasing adiponectin or a food (e.g. food for specified health use) to which a label indicating such physiological activities, such as a label recommending the use for a person with high blood-glucose level, is given.

The content of the Angelica keiskei chalcones in the Angelica keiskei tea beverage containing the formulated Angelica keiskei chalcones is not particularly limited, and the total amount of 4-hydroxyderricin and xanthoangelol in the beverage can preferably be 0.0001 to 50 mg/100 mL, more preferably 0.001 to 25 mg/100 mL, further preferably 0.01 to 20 mg/100 mL. It is possible to conveniently enjoy the functions of the Angelica keiskei chalcones by ingesting the beverage.

The ingesting form of the Angelica keiskei chalcone formulated functional beverage is not particularly limited, and a form allowing to consume about 5 mg ingestion of 4-hydroxyderricin as the Angelica keiskei chalcones per day is preferred. The Angelica keiskei chalcone content can be selected in accordance with a daily total ingesting amount.

(7) Filling and Sterilization Step

In the case of providing the Angelica keiskei tea beverage obtained by the blending step as a container-packed beverage, a step for filling in a container is carried out. Containers conventionally used for beverages can be used without particular limitation, and examples thereof include a can, a bottle, a PET bottle, a paper container, and the like. Filling of the Angelica keiskei tea beverage is carried out by filling the Angelica keiskei tea beverage obtained by the step (6) in a container using a known machine. If necessary, the filling can be carried out after carrying out elimination of precipitates by centrifugation, filtration, and a heat treatment of the Angelica keiskei tea beverage obtained by the step (6).

A conventional sterilization method that has usually been employed for beverages can be carried out without particular limitation, and examples thereof include retort sterilization, high temperature short time sterilization, low temperature long time pasteurization, filtration sterilization, and the like. The retort sterilization generally means sterilization by wet-heating under pressure at a temperature exceeding 100° C., and can be employed in the case of filling into metal cans which can be subjected to heat sterilization after filling. In the case of a PET bottle, a paper container, and the like that cannot be subjected to retort sterilization, another method can be employed. For example, a high temperature short time sterilization method under sterilization conditions similar to those described above by using a plate type heat exchanger or the like can be carried out, followed by cooling to a certain temperature, and then filling into containers. In the case of the retort sterilization, the container-packed Angelica keiskei tea beverage can preferably be subjected to the retort sterilization by using a known retort sterilization apparatus at a temperature of 105° C. to 150° C., more preferably 110° C. to 130° C., further preferably 115° C. to 125° C. The retort sterilization can preferably be carried out at an F₀ value (sterilization intensity) of 4 to 80, more preferably 10 to 70, further preferably 15 to 60. Herein, when the F₀ value at 121° C. for one minute is taken as 1, sterilization conditions at 121° C. for 4 minutes mean that a central part of the object to be sterilized is retained at 121° C. for 4 minutes. After the retort sterilization, cooling can be carried out by standing to cool, or the like.

According to the present invention, a process for producing the above-mentioned Angelica keiskei tea leaves is also provided. That is, the present invention provides a process for producing the kneading-free Angelica keiskei tea leaves comprising the following steps (a) and (b):

(a) a step for drying Angelica keiskei; and
(b) a step for subjecting the dried material of Angelica keiskei obtained by the step (a) to a roast-heating treatment.

One example of the step (a) is a step for subjecting Angelica keiskei after blanching to a dying treatment for achieving a moisture content of 20% or less. One example of the roasting temperature in the step (b) is 100° C. to 150° C.

Further, the present invention provides a process for producing an Angelica keiskei tea beverage by using the kneading-free Angelica keiskei tea leaves obtained by the above production process. As one aspect of the production process, a process for producing a retort-sterilized Angelica keiskei tea beverage is provided, and examples thereof include the process the retort sterilization is carried out in the presence of an antioxidant. Further, the Angelica keiskei chalcones can be formulated in the tea beverage.

Details of the production processes of the kneading-free Angelica keiskei tea leaves and the Angelica keiskei tea beverage are as described with respect to the above-mentioned kneading-free Angelica keiskei tea leaves and the Angelica keiskei tea beverage.

According to the present invention, the Angelica keiskei tea beverage comprising the formulated Angelica keiskei chalcones is provided. The Angelica keiskei tea beverage to which the Angelica keiskei chalcones are formulated is not limited to that obtainable by the present invention as far as it is an Angelica keiskei tea beverage obtained by using Angelica keiskei as a raw material. The production process of the Angelica keiskei chalcones is not limited, either. It is sufficient that the Angelica keiskei chalcones in an effective amount for exhibiting the physiological activities of the Angelica keiskei chalcones is contained in the Angelica keiskei chalcone-formulated Angelica keiskei tea beverage, and such Angelica keiskei tea beverage is provided as an Angelica keiskei tea beverage to be used for health improvement and food for specified health use having the physiological activities of the Angelica keiskei chalcones, such as an effect of lowering a blood-glucose level and an effect of increasing adiponectin.

It is possible to produce foods and beverages by using the Angelica keiskei tea leaves as they are or Angelica keiskei tea leaves-derived materials such as a powder and an extract.

Raw materials that have heretofore been used for the production of foods and beverages can be used in the foods and beverages of the present invention. Edible materials can be used as the raw materials, and examples thereof include carbohydrate such as a fructose glucose syrup, a white sugar, granulated sugar, fructose, glucose, oligosaccharides, starch syrup; and/or a sweetener such as aspartame, stevia, fucose, miraculin, luohanguo; and/or a seasoning such as a protein degradation product, an amino acid solution, a yeast extract, glutamic acid, a tasting nucleic acid, arginine, asparagine, and a whey mineral; and/or a coloring agent such as red cabbage, annatto, carotenoid, flavonoid, and anthocyanin; and/or an emulsifier such as glycerin fatty acid ester; and/or a vitamin enrichment agent such as vitamin A, carotene, vitamin B1, vitamin B2, vitamin B6, vitamin B12, vitamin D, vitamin E, and folic acid; and/or a preparation agent for production such as silicone; and/or a mineral agent such as a salt, potassium chloride, a salt of magnesium, a salt of iron; and/or a thickener such as gellan gum, a locust bean gum, tamarind seed gum, a xanthan gum, carrageenan, a guar gum, pectin, a crystal cellulose, carboxymethylcellulose, glucomannan, agar, sodium alginate, chitin, and glucosamine; and/or an edible raw material such as edible fiber; and/or a functional material such as propolis, sesamin, royal jelly, a ginseng extract, a garlic extract, and turmeric; food additives; and the like.

As used herein, the foods and beverages mean those containing a material derived from the Angelica keiskei tea leaves, and examples thereof include confectionary and breads, meals and noodles, agricultural and forest processed products, livestock processed products, milk and dairy products, fats and processed fat products, alcohol beverages, beverages, seasonings, edible raw materials, and the like. Particularly, when used for beverages, alcohol-containing beverage, soups, seasonings, and the like, it is possible to obtain foods and beverages to which a brand new taste is added. The amount to be added can be appropriately selected within a range of excess of 0% to less than 100%.

The production process of the foods and beverages of the present invention is not particularly limited, and includes production processes of foods or beverages generally used for cooking and processing as far as a material derived from the Angelica keiskei tea leaves is contained in the foods and beverages thus produced. That is, a material derived from the Angelica keiskei tea leaves can be added before cooking or processing, during cooking or processing, or after cooking or processing, or a cooked or processed material, or a raw material thereof can be added to a material derived from the Angelica keiskei tea leaves to dilute the material derived from the Angelica keiskei tea leaves. Also, a mixture obtained by mixing the Angelica keiskei tea leaves or the Angelica keiskei tea beverage of the present invention with another kind of tea leaves or tea beverage such as green tea leaves, oolong tea leaves, red tea leaves, black tea leaves, puh-er tea leaves, houttuynia cordata tea leaves, brown rice tea leaves, or tea beverages thereof are within the scope of the present invention.

Hereinafter, the present invention will be more specifically described by using Examples, but the present invention is not limited to the descriptions at all. Note that % in the Examples means (w/v) % unless otherwise stated.

### EXAMPLES

The samples prepared in the following Examples were evaluated by a sensory evaluation test by 5 panelists in charge of food development. The evaluation standard is shown in Table 1. Overall evaluation was carried out by taking the raw smell/bitterness as a negative evaluation.

TABLE 1

| Rating | Evaluation |
|---|---|
| 0 | not sensed |
| 1 | very weakly sensed |
| 2 | slightly weakly sensed |
| 3 | weakly sensed |
| 4 | slightly strongly sensed |
| 5 | strongly sensed |

### Example 1

### (1) Preparation of Kneaded Angelica keiskei Tea Beverage

Harvested Angelica keiskei were washed, and the washed Angelica keiskei were subjected to a steaming treatment by heating with steam at 100° C. for 0.5 to 1 minute in a steamer (manufactured by Miyamura Tekkousho). Then, moisture was removed with carrying out a coarse kneading step by using a coarse kneading apparatus manufactured by Terada Seisaku-sho so that the moisture content became 7%. The obtained coarsely kneaded material was subjected to a roast-heating treatment by using an exhaust dryer-roaster manufactured by Yokoyama Seisakusho until the product temperature of the coarsely kneaded material reached to 100° C. from the start of roasting. The obtained roast-heated material (Angelica keiskei tea leaves) was extracted at a concentration of 1% with hot water of 100° C. for 10 minutes. After the hot water extraction, filtration through a tea strainer was carried out to prepare a kneaded Angelica keiskei tea beverage, followed by a sensory evaluation.

### (2) Preparation of Kneading-Free Angelica keiskei Tea Beverage

Steamed leaves of Angelica keiskei prepared according to the same manner as in Example 1-(1) was subjected to a first drying treatment by heating at an inside temperature of 90° C. to 120° C. with Rotothrough SRTA-60, a rotating air-flow dryer (manufactured by Okawara MFG Co., Ltd.), and then a second drying treatment was carried out by heating at a hot air temperature of 60° C. for 10 hours in a hot air food dryer, a box type air-flow dryer (manufactured by Wako), to prepare a dried material of Angelica keiskei (moisture content: 7%). The obtained dried material was subjected to a roast-heating treatment with an exhaust drier-roaster until a temperature of the dried material reached to 100° C. from the start of roasting. The obtained roast-heated material (Angelica keiskei tea leaves) was extracted at a concentration of 1% with hot water of 100° C. for 10 minutes. After the extraction, filtration through a tea strainer was carried out to prepare a kneading-free Angelica keiskei tea beverage, followed by a sensory evaluation.

### (3) Sensory Evaluation Test

Results of the sensory evaluation test are shown in Table 2. As shown in Table 2, both of the tea beverages were equal to each other in terms of sweetness and aroma.

However, a raw smell was recognized in the kneaded Angelica keiskei tea beverage, while such raw smell was not recognized in the kneading-free Angelica keiskei tea beverage. Namely, the unpleasant flavor of the prepared beverage was caused by the kneading step. Further, the production of the kneading-free Angelica keiskei tea beverage was preferred because the process comprises the step for roasting the dried material of Angelica keiskei but did not contain a kneading step, thereby simplifying the process and reducing production costs.

TABLE 2

| | Sample | |
|---|---|---|
| | | Kneading-free |
| | Kneaded Angelica keiskei | Angelica keiskei |
| Evaluation | Tea Beverage | Tea Beverage |
| Sweetness | 4.0 | 4.2 |
| Aroma | 0.8 | 0.8 |
| Raw Smell | −3.2 | 0 |
| Overall Evaluation | 1.6 | 5.0 |

### Example 2

### (1) Preparation of Angelica keiskei Tea Beverage Treated at Various Roasting Temperatures

The dried material of Angelica keiskei prepared according to the same manner as in Example 1-(2) was subjected to each roast-heating treatment until reaching to a preset temperature of 85° C., 100° C., 110° C., 120° C., 130° C., 135° C., 140° C., 150° C., or 160° C. The obtained roast heated material (Angelica keiskei tea leaves) was extracted at a concentration of 1% with hot water of 100° C. for 10 minutes. After hot water extraction, each of the tea beverages obtained by the various roasting temperatures was filtered through a tea strainer, followed by the sensory evaluation.

### (2) Sensory Evaluation Test

Results of the sensory evaluation test of the tea beverages treated at the various temperatures are shown in Tables 3 and 4. As shown in Tables 3 and 4, excellent sweetness was resulted from the heat treatment at 100° C. to 120° C., excellent aroma was resulted from the heat treatment at 120° C. to 150° C., a raw smell was recognized at the temperature of 85° C. or less, and bitterness due to the roasting was recognized at 160° C. or higher. As the overall evaluation, it was revealed that the roasting temperature of 100° C. to 150° C. was preferable in the present invention, and it was found that it was possible to provide the kneading-free Angelica keiskei tea beverage exhibiting various functions.

TABLE 3

| | Roasting Temperature (° C.) | | | | |
|---|---|---|---|---|---|
| Evaluation | 85 | 100 | 110 | 120 | 130 |
| Sweetness | 2.8 | 4.2 | 4.8 | 3.8 | 2.8 |
| Aroma | 0.6 | 0.8 | 1.4 | 2.2 | 3.0 |
| Raw Smell | −3.0 | 0 | 0 | 0 | 0 |
| Bitterness | 0 | 0 | 0 | 0 | 0 |
| Overall | 0.4 | 5.0 | 6.2 | 6.0 | 5.8 |
| Evaluation | | | | | |

TABLE 4

Roasting Temperature (° C.)

| Evaluation | 135 | 140 | 150 | 160 |
|---|---|---|---|---|
| Sweetness | 2.0 | 1.4 | 1.2 | 0.8 |
| Aroma | 4.2 | 4.8 | 5.0 | 5.0 |
| Raw Smell | 0 | 0 | 0 | 0 |
| Bitterness | 0 | −1.0 | −3.2 | −4.8 |
| Overall | 6.2 | 5.2 | 3.0 | 1.0 |
| Evaluation | | | | |

### Example 3

### (1) Study of Concentration of Roast-Heated Angelica keiskei Tea Leaves Subjected to Extraction

The dried material of the Angelica keiskei prepared according to the same manner as in Example 1-(2) was heated until reaching to preset temperatures of 110° C. or 135° C. to prepare 110° C. roast-heated Angelica keiskei tea leaves and 135° C. roast-heated Angelica keiskei tea leaves. At a concentration of 0.25%, 0.5%, 1%, 2%, or 3%, the 110° C. roast-heated Angelica keiskei tea leaves were extracted with hot water of 100° C. for 10 minutes, and the 135° C. roast-heated Angelica keiskei tea leaves were extracted with hot water of 65° C. for 10 minutes. After the extraction, the Angelica keiskei tea beverages were obtained by filtering each of them through a tea strainer, followed by the sensory evaluation.

### (2) Sensory Evaluation Test

As to the sensory evaluation test of the Angelica keiskei tea beverages, results of the 110° C. roast-heated Angelica keiskei tea beverages are shown in Table 5, and results of the 135° C. roast-heated Angelica keiskei tea beverages are shown in Table 6. As shown in Tables 5 and 6, richness and tastiness were not recognized when the concentration of the Angelica keiskei tea leaves was small, and bitterness was strengthened when the concentration of the Angelica keiskei tea leaves was increased. Therefore, it was revealed that the concentration of the Angelica keiskei tea leaves for the Angelica keiskei tea beverage is preferably 0.25% to 3%, more preferably 0.5% to 2%, and further preferably 1% in terms of richness and tastiness.

TABLE 5

| | Concentration of 110° C. Roast-Heated | | | | |
|---|---|---|---|---|---|
| | Angelica keiskei Tea Leaves (%) | | | | |
| Evaluation | 0.25 | 0.5 | 1 | 2 | 3 |
| Richness and | 1.4 | 3.2 | 4.6 | 4.8 | 4.8 |
| Tastiness | | | | | |
| Raw Smell | 0 | 0 | 0 | 0 | 0 |
| Bitterness | 0 | 0 | 0 | −1.2 | −2.8 |
| Overall | 1.4 | 3.2 | 4.6 | 3.6 | 2.0 |
| Evaluation | | | | | |

TABLE 6

| | Concentration of 135° C. Roast-Heated | | | | |
|---|---|---|---|---|---|
| | Angelica keiskei Tea Leaves (%) | | | | |
| Evaluation | 0.25 | 0.5 | 1 | 2 | 3 |
| Richness and | 1.2 | 2.8 | 4.6 | 4.8 | 5.0 |
| Tastiness | | | | | |
| Raw Smell | 0 | 0 | 0 | 0 | 0 |
| Bitterness | 0 | 0 | 0 | −1.8 | −4.2 |
| Overall | 1.2 | 2.8 | 4.6 | 3.0 | 0.8 |
| Evaluation | | | | | |

### Example 4

### (1) Study of Extraction Temperature

The dried material of the Angelica keiskei prepared according to the same manner as in Example 1-(2) was subjected to a roast-heating treatment until reaching to a present temperature of 135° C. The obtained roast-heated material (Angelica keiskei tea leaves) was extracted at a concentration of 1% with hot water of 35° C., 50° C., 65° C., 85° C., or 100° C. for 10 minutes. After the hot water extraction, each of the Angelica keiskei tea beverages treated at the various extraction temperatures was prepared by filtering through a tea strainer, followed by the sensory evaluation.

### (2) Sensory Evaluation Test

Results of the sensory evaluation test of the Angelica keiskei tea beverages treated at the various extraction temperatures are shown in Table 7. As shown in Table 7, components relating to richness and tastiness were not extracted in the Angelica keiskei tea beverage obtained at the extraction temperature of 35° C., and the Angelica keiskei tea beverage had a weak impression. In contrast, the Angelica keiskei tea beverages obtained at the extraction liquid temperatures of 50° C. or higher were excellent in richness and tastiness, and, particularly, the Angelica keiskei tea beverages obtained at the extraction temperatures of 65° C. or higher were more excellent in richness and tastiness.

TABLE 7

| | Extraction Temperature (° C.) | | | | |
|---|---|---|---|---|---|
| Evaluation | 35 | 50 | 65 | 85 | 100 |
| Richness and | 2.4 | 4.2 | 4.6 | 4.8 | 4.6 |
| Tastiness | | | | | |

### Example 5

### (1) Preparation of Angelica keiskei Tea Beverage from Mixture of Angelica keiskei Tea Leaves Subjected to Roast-Heating Treatments at Roasting Temperatures of 110° C. and 135° C., Respectively

The dried material of the Angelica keiskei leaves prepared according to the same manner as in Example 1-(2) was subjected to a roast-heating treatment until reaching to preset temperatures of 110° C. or 135° C. Each of the 110° C. roasted Angelica keiskei tea leaves, a mixture of the 110° C. roasted Angelica keiskei tea leaves and the 135° C. roasted Angelica keiskei tea leaves at a ratio of 3:1, a mixture of the 110° C. roasted Angelica keiskei tea leaves and the 135° C. roasted Angelica keiskei tea leaves at a ratio of 1:1, and the 135° C. roasted Angelica keiskei tea leaves at a concentration of 1% was extracted with hot water of 100° C. for 10 minutes. After the extraction, the Angelica keiskei tea beverages were prepared by subjecting each of them to filtration through a tea strainer, followed by the sensory evaluation.

### (2) Sensory Evaluation Test

Results of the sensory evaluation test of the Angelica keiskei tea beverages are shown in Table 8. As shown in Table 8, characteristics of flavor of each of the 110° C. roasted Angelica keiskei tea leaves and the 135° C. roasted Angelica keiskei tea leaves were enhanced when the tea leaves were mixed at the certain ratio as compared with the case of separately extracting each of the tea leaves.

TABLE 8

Mixing Ratio of Roast-Heated Materials

| | | 110° C.: | 110° C.: | |
|---|---|---|---|---|
| | 110° C. | 135° C. = | 135° C. = | 135° C. |
| Evaluation | only | 3:1 | 1:1 | only |
| Sweetness | 4.8 | 3.4 | 3.2 | 2.0 |
| Aroma | 1.4 | 2.8 | 3.6 | 4.2 |
| Raw smell and | 0 | 0 | 0 | 0 |
| Bitterness | | | | |
| Overall | 6.2 | 6.2 | 6.8 | 6.2 |
| Evaluation | | | | |

### Example 6

Each of the Angelica keiskei tea beverages obtained in Example 5-(1) was filled in cans and subjected to retort sterilization (121° C., 20 minutes) to prepare a retort sterilized Angelica keiskei tea beverage.

Results of sensory evaluation test of the Angelica keiskei tea beverages are shown in Table 9. As shown in Table 9, in the case of carrying out the retort sterilization, the 110° C. roasted Angelica keiskei tea beverage was changed in flavor and a raw smell was recognized in the tea beverage. However, a sweetness was extracted in the 135° C. roasted Angelica keiskei tea beverage. Therefore, it was found that the higher roasting temperature was preferably employed in the case of carrying out the retort sterilization. Namely, it was found that the mixture of the 110° C. roasted Angelica keiskei tea leaves and the 135° C. roasted Angelica keiskei tea leaves or the single use of the 135° C. roasted Angelica keiskei tea leaves were suitable for the case of carrying out a retort treatment.

TABLE 9

Mixing Ratio of Roast-Heated Materials

| | | 110° C.: | 110° C.: | |
|---|---|---|---|---|
| | 110° C. | 135° C. = | 135° C. = | 135° C. |
| Evaluation | only | 3:1 | 1:1 | only |
| Sweetness | 3.8 | 3.0 | 2.8 | 3.8 |
| Aroma | 1.4 | 2.8 | 3.6 | 4.2 |
| Raw Smell | −1.8 | −1.6 | −1.0 | 0 |
| and | | | | |
| Bitterness | | | | |
| Overall | 3.4 | 4.2 | 5.4 | 8.0 |
| Evaluation | | | | |

### Example 7

### (1) Study on Antioxidant in Retort Sterilization

The dried material of the Angelica keiskei prepared according to the same manner as in Example 1-(2) was subjected to a roast-heating treatment until reaching to a preset temperature of 135° C. The obtained roasted Angelica keiskei tea leaves were subjected to extraction at a concentration of 1% and at temperatures of 65° C., 85° C., or 100° C. for 10 minutes. After the extraction, filtration through a tea strainer was carried out, and tea beverages to which ascorbic acid was added at a concentration of 0.02% as an antioxidant or to which the antioxidant was not added were prepared. Baking soda was added at a final concentration of 0.026% to those to which ascorbic acid was added in order to adjust the pH to about 6.1. Each of the tea beverages was filled in cans, followed by retort sterilization (121° C., 20 minutes). Sensory evaluation was carried out on the thus-obtained tea beverages.

### (2) Sensory Evaluation Test

Results of the sensory evaluation test of the Angelica keiskei tea beverages prepared in Example 7-(1) are shown in Table 10. As shown in Table 10, mellowness was added to the flavor at each of the extraction temperatures (65° C., 85° C., and 100° C.) by the retort sterilization carried out after addition of ascorbic acid as compared with the cases without addition of ascorbic acid. It was revealed that the addition of ascorbic acid was preferred in the case of carrying out the retort sterilization.

TABLE 10

| | Ascorbic Acid Was Not | | | Ascorbic Acid Was Added | | |
|---|---|---|---|---|---|---|
| | Added | | | (After Extraction) | | |
| | Extraction Liquid Temperature (° C.) | | | | | |
| Evaluation | 65 | 85 | 100 | 65 | 85 | 100 |
| Sweetness | 4.6 | 4.0 | 3.8 | 4.8 | 4.2 | 4.0 |
| Aroma | 4.2 | 4.2 | 4.2 | 4.0 | 4.0 | 4.2 |
| Mellowness | 0 | 0 | 0 | 2.8 | 2.6 | 1.2 |
| Overall | 8.8 | 8.2 | 8.0 | 11.6 | 10.8 | 9.4 |
| Evaluation | | | | | | |

### Example 8

### (1) Study of Timing of Addition of Ascorbic Acid

The dried material of the Angelica keiskei obtained according to the same manner as in Example 1-(2) was subjected to a roast-heating treatment until reaching to a preset temperature of 135° C. The obtained roasted Angelica keiskei tea leaves were subjected to extraction at a concentration of 1% with hot water of 65° C. to which ascorbic acid was added at a concentration of 0.02% for 10 minutes. After the extraction, filtration through a tea strainer was carried out, and baking soda was added at a final concentration of 0.035% in order to adjust the pH to about 6.1. After the pH adjustment, the beverage was filled in cans, and subjected to retort sterilization (121° C., 20 minutes) to prepare an Angelica keiskei tea beverage to which ascorbic acid was added before extraction, and then sensory evaluation was carried out.

The Angelica keiskei tea leaves were subjected to extraction at a concentration of 1% with hot water of 65° C. for 10 minutes, and, after filtering through a tea strainer, ascorbic acid was added at a concentration of 0.02%, followed by adding baking soda at a final concentration of 0.026% in order to adjust the pH to about 6.1. After the pH adjustment, the beverage was filled in cans, and subjected to retort sterilization (121° C., 20 minutes) to prepare an Angelica keiskei tea beverage, to which ascorbic acid was added after extraction, and then sensory evaluation was carried out.

### (2) Sensory Evaluation

Results of the sensory evaluation test of the Angelica keiskei tea beverages prepared in Example 8-(1) are shown in Table 11. As shown in Table 11, it was revealed that, though both of the timings for addition of ascorbic acid of before extraction and after extraction were preferable, the timing before extraction was more preferred.

TABLE 11

Timing for Addition

| Evaluation | Before Extraction | After Extraction |
|---|---|---|
| Sweetness | 4.8 | 4.8 |
| Aroma | 3.8 | 4.0 |
| Mellowness | 3.4 | 2.8 |
| Overall | 12.0 | 11.6 |
| Evaluation | | |

### Example 9

### (1) Preparation of Hydrous Alcohol Extract of Angelica keiskei

To 30 L of deionized water at 90° C., 1 kg of a dried material of Angelica keiskei leaves and stems in the form of chips obtained by crushing was added, followed by heating for 10 minutes. After cooling to room temperature, the boiled Angelica keiskei was washed with 30 L of deionized water and drained by filtration, followed by elimination of moisture by using a juicer press. The moisture content of the pressed residue was measured, and hydrous ethanol was added to the pressed residue so that 20 L of 60% (v/v) ethanol was finally contained in the pressed residue, followed by extraction overnight with intermittently stirring. Subsequently, the liquid extract was separated from the extraction residue by filtration, and additional liquid extract was recovered by pressing the extraction residue with a juicer press. The liquid extracts were combined and filtrated by using a celite 500 (manufactured by Nacalai Tesque) to eliminate insoluble components. The Celite filtrate was subjected to concentration under reduced pressure by using a rotary evaporator, and the concentrate was dissolved in 80% (v/v) ethanol to prepare 66 mL of a hydrous alcohol extract of Angelica keiskei. A solid content of the extract was 428 mg/mL, and the concentration of the Angelica keiskei chalcones was 20.5 mg/mL as the sum of xanthoangelol and 4-hydroxyderricin.

### (2) Preparation of Chalcone-Containing Composition

Ethanol was eliminated from 10.0 mL of the hydrous alcohol extract of Angelica keiskei prepared in Example 9-(1) by concentration under reduced pressure, and 20 g polyglycerin fatty acid ester (trade name: MM-750 (manufactured by Sakamoto Yakuhin Kogyo Co., Ltd.)) was added as an emulsifier, followed by adding deionized water so that a total amount became 200 mL. The mixture was stirred with a homomixer at 60° C. at 10,000 rpm for 10 minutes to obtain an Angelica keiskei chalcone-containing composition.

### Example 10

### (1) Preparation of Angelica keiskei Tea Beverage Comprising Formulated Angelica keiskei Chalcones—1

The dried material of the Angelica keiskei prepared according to the same manner as in Example 1-(2) was subjected to a roast-heating treatment until reaching to a preset temperature of 135° C. The obtained roasted Angelica keiskei tea leaves were subjected to extraction at a concentration of 1% with hot water of 65° C. to which ascorbic acid was added at a concentration of 0.02% for 10 minutes. After the extraction, filtration through a tea strainer was carried out, and baking soda was added at a final concentration of 0.035% in order to adjust the pH to about 6.1. After the pH adjustment, the Angelica keiskei chalcone-containing composition prepared in Example 9 was added at a final concentration of 0.01 mg/100 mL, followed by filling in cans. As a control, an extract that did not contain the Angelica keiskei chalcone-containing composition was filled in cans. The canned tea beverages were subjected to retort sterilization (121° C., 20 minutes) to prepare Angelica keiskei chalcone-containing beverages, followed by sensory evaluation.

### (2) Sensory Evaluation Test

Results of the sensory evaluation test of the samples prepared in Example 10-(1) are shown in Table 12. As shown in Table 12, the flavor was not influenced by addition of Angelica keiskei chalcones.

TABLE 12

Addition of Chalcone-Containing Composition

| Evaluation | Not Added | Added |
|---|---|---|
| Sweetness | 4.8 | 4.8 |
| Aroma | 3.8 | 3.8 |
| Mellowness | 3.4 | 3.4 |
| Overall | 12.0 | 12.0 |
| Evaluation | | |

### (3) Preparation of Angelica keiskei Tea Beverage Comprising Formulated Angelica keiskei Chalcones—2

Similarly, the Angelica keiskei chalcone-containing composition was added at an Angelica keiskei chalcone concentration of 3 mg/100 mL, followed by retort sterilization (121° C., 20 minutes) to prepare an Angelica keiskei chalcone-formulated beverage having a good flavor.

Further, similarly, the Angelica keiskei chalcone-containing composition was added at an Angelica keiskei chalcone concentration of 15 mg/100 mL, followed by retort sterilization (121° C., 20 minutes) to prepare an Angelica keiskei chalcone-formulated beverage.

### Example 11

The dried material of the Angelica keiskei prepared in the same manner as in Example 1-(2) was subjected to a roast-heating treatment until reaching to a preset temperature of 110° C. The obtained roasted Angelica keiskei tea leaves were pulverized to prepare tea bags each containing 5 g of the tea leaves. In addition, the Angelica keiskei tea leaves prepared according to the same manner as in Example 1-(1) was used for preparing a control Each of the tea bag was placed in a pot, followed by pouring about 400 mL of hot water, thereby obtaining an Angelica keiskei tea beverage. The product of the present invention exhibited a good flavor as compared with the control.

### Example 12

The dried material of the Angelica keiskei prepared according to the same manner as in Example 1-(2) was subjected to a roast-heating treatment until reaching to a preset temperature of 110° C. The obtained roasted Angelica keiskei tea leaves were pulverized, and 4.7 kg of a fish powder, 0.8 kg of the pulverized Angelica keiskei tea leaves, 2.5 kg of sesame, 1.0 kg of a salt, and 0.5 kg of monosodium glutamate were mixed, followed by granulation to prepare a furikake (seasoning for cooked rice) according to a conventional method.

In addition, the Angelica keiskei tea leaves prepared according to the same manner as in Example 1-(1) was used for preparing a control in the same manner.

The product of the present invention exhibited a good flavor as compared with the control.

### Example 13

The dried material of the Angelica keiskei prepared according to the same manner as in Example 1-(2) was subjected to a roast-heating treatment until reaching to a preset temperature of 135° C. A leaf-derived part of the obtained roasted Angelica keiskei tea leaves was shredded, and 1.0 kg of the shredded Angelica keiskei tea leaves, 2.0 kg of a cubic rice cracker, 2.3 kg of a salt, 0.7 kg of an umami (tasty) seasoning were mixed as a seasoning for chaduke (cooked rice served with tea). One package contained 6 g of the seasoning for chaduke was prepared.

Also, a leaf-derived part of the Angelica keiskei tea leaves prepared in the same manner as in Example 1-(1) was used for preparing a control in the same manner.

The product of the present invention exhibited a good flavor as compared with the control.

### Example 14

### (1) Preparation of Tea Bag Containing Only Roasted Leaves of Angelica keiskei

The dried material of Angelica keiskei leaves prepared in the same manner as in Example 1-(2) by using only the leaves of Angelica keiskei were subjected to a roast-heating treatment until reaching to preset temperatures of 100° C., 110° C., 120° C., 130° C., 140° C., 145° C., 150° C., or 160° C. The Angelica keiskei tea leaves were pulverized to prepare tea bags each containing 2 g of the pulverized tea leaves. Each of the tea bags prepared at the different roasting temperatures was placed in a pot, followed by pouring about 300 mL of hot water to prepare an Angelica keiskei tea beverage, and then sensory evaluation was carried out.

### (2) Sensory Evaluation Test

Results of the sensory evaluation test of the tea beverages treated at the different roasting temperatures are show in Tables 13 and 14. As shown in Tables 13 and 14, it was evaluated that components relating to richness and tastiness were well extracted generally in the Angelica keiskei tea beverages prepared by using only the leaves of the Angelica keiskei. The favorable richness and tastiness were achieved with the materials treated at 120° C. to 160° C., and the materials treated at 120° C. to 150° C. were optimum due to the reduction in bitterness. Thus, a high quality tea leaves free from undesirably strong taste was provided.

TABLE 13

Roasting Temperature (° C.)

| Evaluation | 100 | 110 | 120 | 130 |
|---|---|---|---|---|
| Sweetness | 1.6 | 1.8 | 1.2 | 0.8 |
| Aroma | 0.2 | 0.8 | 1.2 | 2.6 |
| Raw Smell | −0.6 | −0.4 | 0 | 0 |
| Bitterness | 0 | 0 | 0 | 0 |
| Richness and | 0.6 | 0.8 | 1.4 | 2.2 |
| Tastiness | | | | |
| Overall | 1.8 | 3.0 | 3.8 | 5.6 |
| Evaluation | | | | |

TABLE 14

Roasting Temperature (° C.)

| Evaluation | 140 | 145 | 150 | 160 |
|---|---|---|---|---|
| Sweetness | 0.4 | 0.2 | 0.2 | 0 |
| Aroma | 3.8 | 4.0 | 4.2 | 5.0 |
| Raw Smell | 0 | 0 | 0 | 0 |
| Bitterness | 0 | 0 | −0.6 | −3.2 |
| Richness and | 2.4 | 2.4 | 2.4 | 2.8 |
| Tastiness | | | | |
| Overall | 6.6 | 6.6 | 6.2 | 4.6 |
| Evaluation | | | | |

### Example 15

### (1) Tea Bag of Roasted Dried Material of Angelica keiskei and Preparation of Angelica keiskei Tea Beverage—1

The dried material of Angelica keiskei prepared according to the same manner as in Example 1-(2) was pulverized and subjected to a roast-heating treatment until reaching to preset temperatures of 125° C., 130° C., 135° C., 140° C., 145° C., 150° C., 155° C., or 160° C. The Angelica keiskei tea leaves obtained were used for preparing tea bags each containing 4.5 g of the pulverized tea leaves. 1 L of hot water was boiled in a kettle, and each of the tea bags prepared at the different roasting temperatures was placed in the kettle, followed by boiling for 3 minutes to prepare the Angelica keiskei tea beverages, and then sensory evaluation was carried out.

### (2) Sensory Evaluation Test

Results of the sensory evaluation test of the tea beverages treated at the different roasting temperatures are shown in Tables 15 and 16. As shown in Tables 15 and 16, it was evaluated that the Angelica keiskei tea beverages treated at 135° C. to 160° C. were favorable in terms of richness and tastiness, and the tea beverages treated at 140° C. to 150° C. were optimum due to good in aroma and reduction in bitterness, thereby providing the Angelica keiskei tea beverages having good flavor.

TABLE 15

Roasting Temperature (° C.)

| Evaluation | 125 | 130 | 135 | 140 |
|---|---|---|---|---|
| Sweetness | 1.0 | 0.8 | 0.8 | 0.4 |
| Aroma | 0.2 | 1.0 | 1.0 | 2.8 |
| Raw Smell | 0 | 0 | 0 | 0 |
| Bitterness | 0 | 0 | 0 | 0 |
| Richness and | 1.0 | 1.4 | 2.4 | 2.6 |
| Tastiness | | | | |
| Overall | 2.2 | 3.2 | 4.2 | 5.8 |
| Evaluation | | | | |

TABLE 16

Roasting Temperature (° C.)

| Evaluation | 145 | 150 | 155 | 160 |
|---|---|---|---|---|
| Sweetness | 0.4 | 0.2 | 0 | 0 |
| Aroma | 3.0 | 4.2 | 4.4 | 4.8 |
| Raw Smell | 0 | 0 | 0 | 0 |
| Bitterness | 0 | −0.6 | −3.2 | −3.8 |
| Richness and | 2.8 | 2.8 | 2.8 | 2.8 |
| Tastiness | | | | |
| Overall | 6.2 | 6.6 | 4.0 | 3.8 |
| Evaluation | | | | |

### (3) Tea Bag of Roasted Dried Material of Angelica keiskei and Preparation of Angelica keiskei Tea Beverage—2

Each of tea bags prepared at different roasting temperatures in the same manner as in Example 15-(1) was placed in 1 L of a water and allowed to stand in a refrigerator having an inside temperature of 4° C. for 2 hours to prepare an Angelica keiskei tea beverage, followed by sensory evaluation.

### (2) Sensory Evaluation Test

Results of the sensory evaluation test of the tea beverages treated at the different roasting temperatures are shown in Tables 17 and 18. As shown in Tables 17 and 18, it was evaluated that the Angelica keiskei tea beverages treated at 135° C. to 160° C. were favorable in terms of richness and tastiness, and the tea beverages treated at 140° C. to 150° C. were optimum due to good in aroma and reduction in bitterness, thereby providing the Angelica keiskei tea beverages having good flavor.

TABLE 17

Roasting Temperature (° C.)

| Evaluation | 125 | 130 | 135 | 140 |
|---|---|---|---|---|
| Sweetness | 0.8 | 0.8 | 0.8 | 0.6 |
| Aroma | 0.2 | 0.8 | 1.2 | 2.4 |
| Raw Smell | 0 | 0 | 0 | 0 |
| Bitterness | 0 | 0 | 0 | 0 |
| Richness and | 0.8 | 1.4 | 2.2 | 2.4 |
| Tastiness | | | | |
| Overall | 1.8 | 3.0 | 4.2 | 5.4 |
| Evaluation | | | | |

TABLE 18

Roasting Temperature (° C.)

| Evaluation | 145 | 150 | 155 | 160 |
|---|---|---|---|---|
| Sweetness | 0.4 | 0.2 | 0 | 0 |
| Aroma | 2.6 | 3.2 | 3.6 | 4.0 |
| Raw Smell | 0 | 0 | 0 | 0 |
| Bitterness | 0 | −0.4 | −2.2 | −3.4 |
| Richness and | 2.6 | 2.6 | 2.6 | 2.6 |
| Tastiness | | | | |
| Overall | 5.6 | 5.6 | 4.0 | 3.2 |
| Evaluation | | | | |

### INDUSTRIAL APPLICABILITY

According to the present invention, there are provided Angelica keiskei tea leaves whose grassy smell, vegetable-like taste, and harsh taste that are peculiar to Angelica keiskei are reduced as well as whose flavor in terms of richness, sweetness, and aroma is improved; a high quality Angelica keiskei tea beverage having mellowness in addition to the above-described characteristics; an Angelica keiskei tea beverage comprising formulated Angelica keiskei chalcones; and a process for producing thereof. Since the production process does not include any kneading steps such as coarse kneading, rolling, intermediate kneading, or fine kneading, the production process is extremely simplified as compared with a conventional process.

1. Kneading-free Angelica keiskei tea leaves obtainable by a treatment comprising a step for roast-heating a dried material of Angelica keiskei.

2. The kneading-free Angelica keiskei tea leaves according to claim 1, wherein a heating temperature in the roast-heating treatment is 100° C. to 150° C.

3. The kneading-free Angelica keiskei tea leaves according to claim 1 or 2, wherein the dried material of Angelica keiskei is obtained by a dry heating treatment after blanching, and has a moisture content of 20% or less.

4. An Angelica keiskei tea beverage produced by using the kneading-free Angelica keiskei tea leaves according to any one of claims 1 to 3.

5. The Angelica keiskei tea beverage according to claim 4, wherein the Angelica keiskei tea beverage is subjected to retort sterilization in the presence of an antioxidant.

6. An Angelica keiskei tea beverage comprising formulated Angelica keiskei chalcones.
